(19) United States
(12) Patent Application Publication
(10) Pub. No.: US 2008/0094986 A1
(43) Pub. Date: Apr. 24, 2008

(54) Method Of Converting A User Bitstream Into Coded Bitstream, Method For Detecting A Synchronization Pattern In A Signal, A Record Carried, A Signal, A Recording Device And A Playback Device All Using A Freely Insertable Synchronization Pattern

(75) Inventor: Willem Marie Julia Marcel Coene, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/575,137

(22) PCT Filed: Sep. 13, 2005
(86) PCT No.: PCT/IB05/52993

§ 371 Date: Mar. 13, 2007

(30) Foreign Application Priority Data
Sep. 17, 2004 (EP) 04104513.9

(51) Int. Cl. G11B 27/30; G11B 27/034; G11B 19/12; G11B 19/14

(52) U.S. Cl. 369/59.23; 375/368; 369/59.24

(57) ABSTRACT

This invention proposes synchronization patterns for RLL codes with a constraint. Instead of including the synchronization pattern in the pattern the pattern is chosen to have p leading bits and q trailing bits such that all channel code constraints are met by the last code word of the section preceding the synchronization pattern together with the p leading bits and by a first code word of the section following the synchronization pattern together with the q trailing bits of the synchronization pattern. This results in a freely insertable synchronization pattern that can be inserted after coding and removed before decoding resulting in an more efficient coder and decoder.

This invention relates to a method of converting a user bitstream into coded bitstream in a signal by means of a channel code, based on a signal format with a number of coded bitstream frames, wherein said channel code has a constraint, comprising the steps of:

coding the user bitstream into the coded bitstream,

partitioning the coded bit stream into a first section and a second section,

generating the synchronization pattern,

inserting the generated synchronization pattern between the first section and the second section.

In RLL sliding-block codes, decoding requires one or more symbols look-ahead. A synchronization pattern, which indicates the start of a new recording frame in an ECC-cluster, may be a break point in the coding history of the sliding block code. State-of-the-art measures are to adopt the next-state diversity within the sync-pattern, as it was implemented in DVD with EFMPlus. This has been disclosed in the DVD Specifications for Read-Only Disc. Part-1: Physical Specifications, August 1996 and in: “120 mm DVD-Read-Only Disk”, Std. ECMA-267, 3rd Ed., April 2001.

In addition such DVD discs, recorders and players have been freely available to the public for a long time now, thus effectively disclosing all aspects of the standard as included in such discs and devices that comply with said DVD standard.

For extremely efficient RLL codes, which are based on a finite-state machine (FSM) with a large number of states, it is advantageous to construct an insertable sync-pattern, which does not obstruct the next-state look-ahead decoding, and which can be pasted without causing any runlength violations. The new sync-pattern can be freely inserted between two consecutive code words of the RLL code; look-ahead decoding for the last code word of a given frame requires the first code word of the subsequent frame, just after the sync pattern, and this is performed as if the sync pattern was not present, that is, the channel bits of the sync pattern are irrelevant.

Data on an optical disc are organized into ECC-clusters (an ECC-cluster is the collection of all stored symbols that constitute together the structure of the (possibly combined) ECC codes); each cluster is typically organized in a number of recording frames, where each recording frame comprises a limited number of symbols (91 for DVD, 155 for BD). Synchronization patterns are required at the start of each recording frame in order to yield the proper starting point for the sequence of channel bits that has to enter the runlength-limited (RLL) decoder: a shift of a single bit is killing for the output of the RLL-decoder. Therefore, synchronization patterns, hereafter shortly called sync-patterns, have to be uniquely identifiable in the main channel bitstream. Commonly, a violation of a k-constraint is used as a typical bit-pattern in the sync (although any other sequence that cannot occur in the channel bitstream as produced by a regular RLL encoder is also a valid unique bit-pattern that may be used: in this context, we could also have as a typical bit-pattern in the sync a sequence of 4 2T runs, when the code has d=1 and r=2, since the pattern obviously violates the RMTR constraint of r=2).

A sliding-block RLL decoder for a rate p→q encoder takes a sequence of q-bit channel words yₙ as its input, and produces a sequence of p-bit symbols xₙ as its output, where each output symbol xₙ only depends on a corresponding sequence yₙ₋ₘ, . . . , yₙ₊ₐ of w=m+1+a consecutive inputs, for some fixed numbers m and a, m≦a. The number w is referred to as the window size of the decoder. Most practical codes are designed to have a window size of 2, with m=0 and a=1: for decoding of a given channel word, one needs also the next channel word in order to uniquely decode the user word. This is also known as a “one-symbol look-ahead decoder.

In a format where symbols or user words are organized in recording frames that are headed by a synchronization pattern, the sync is a break point in the encoding sequence. The problem is that for the last channel word just before the sync of the next recording frame, one cannot apply the one-symbol look-ahead decoding in order to retrieve the next state of the current channel word.

A solution that has been adopted in the DVD format as disclosed in the DVD

Specifications for Read-Only Disc. Part-1: Physical Specifications, August 1996 and in: “120 mm DVD-Read-Only Disk”, Std. ECMA-267, 3rd Ed., April 2001 and by numerous devices and discs that have been freely available to the public for a long time, is that the sync-pattern itself allows to perform the next-state decoding for the last symbol before the sync. In DVD the EFMPlus RLL code is used, which has a 4-state finite-state machine; one-symbol look-ahead decoding is only required if the current channel word has State 2 or State 3 as a possible next state. In EFMPlus, State 2 has both the channel bits at position 1 and position 13 equal to 0, whereas for State 3 at least one of these two positions must be equal to 1. This decoding rule for the next-state is also implemented in the DVD-syncs. In DVD, after the sync-pattern of the next recording frame, the RLL encoder is always reset to be in State 1.

This has the severe disadvantage that such a method for converting a user bitstream into coded bitstream forces the coder and decoder to a particular state after each synchronization pattern, thus reducing the efficiency of the coding and decoding.

It is the objective of the present invention to provide a method for converting a user bitstream into coded bitstream with improved efficiency.

To achieve this objective the invention provides a method where the synchronization pattern comprises p leading bits and q trailing bits such that all channel code constraints are met by a last code word of the first section together with the p leading bits and by a first code word of the second section together with the q trailing bits.

By ensuring that the channel constraints are met by a last code word of the first section together with the p leading bits and by a first code word of the second section together with the q trailing bits the synchronization pattern becomes freely insertable, i.e. the synchronization pattern does not require particular states at the end of the first section or the beginning of the second section between which it is inserted, but instead is easily adapted to the states at the end of the first section or the beginning of the second section by adjusting the p leading bits and the q trailing bits of the synchronization pattern. Hence the synchronization no longer requires the second section to start in a particular state, allowing the coding and decoding to ignore the synchronization pattern thus achieving the improved efficiency.

In an embodiment of the method said channel code is a sliding block code requiring a look-ahead decoding hereby using subsequent code words following a given code word that is to be decoded, and where the look-ahead decoding for the last code word of the first section uses the first code word of the second section, and where the channel bits of the synchronization pattern are irrelevant for said look-ahead decoding.

The decoder's efficiency is improved because by removing the freely insertable synchronization pattern the first section and the second section of the coded bitstream can be joined into a recreated coded bitstream and that bitstream can be decoded.

The synchronization pattern is no longer used in the decoding and efficiency of the decoding thus improved. Previously the decoder had to keep track of where the synchronization pattern was inserted in order to know from where to apply the state prescribed by the synchronization pattern. That is no longer the case.

In an embodiment of the method said look-ahead decoding requires the first code word of the second section for the decoding of the last code word of first section. One of the implementations of the sliding block code that benefits in particular from this invention is a sliding block code where a next code word, following the code word to be decoded is needed in order to decode the code word to be decoded.

This is problematic in the prior art when a synchronization pattern is reached.

Using the present invention allows the continues coding and decoding because the synchronization pattern can be removed from the signal and the remaining first section and second section of the coded bitstream can be joined, i.e. appended, to obtain a recreated coded bitstream where no influence of the synchronization pattern is present and the decoding of a code word can be performed using the next code word in a look ahead decoding. The coding process also doesn't have to take the synchronization pattern into consideration.

A method for converting a coded bitstream in a signal into a user bit stream using a channel code, where the signal comprises a synchronization pattern inserted between a first section of the coded bit stream and a second section of the bit stream where the synchronization pattern comprises p leading bits and q trailing bits such that all channel code constraints are met by a last code word of the first section together with the p leading bits and by a first code word of the second section together with the q trailing bits.

comprises the steps of:

removing the synchronization pattern from the signal,

appending the second section to the first section to obtain e recreated coded bistream,

decoding the recreated coded bitstream into a user bitstream based on the channel code.

Since the synchronization pattern is freely insertable, it can also, for the purpose of decoding, be freely removed. After appending the second section to the first section the coded bitstream as produced by the coder using the channel code is obtained. The coded bitstream complies also with the channel constraints of the channel code used for encoding. The sequence of states is intact without resets or alterations required or introduced by the synchronization pattern. Consequently the decoding can decode the coded bitstream without further complications as would be introduced by a regular synchronization pattern.

An increased efficiency of the decoding process is thus achieved.

In an embodiment of the method said channel code is a sliding block code requiring a look-ahead decoding hereby using subsequent code words following a given code word that is to be decoded.

One of the implementations of the sliding block code that benefits in particular from this invention is a sliding block code where a next code word, following the code word to be decoded is needed in order to decode the code word to be decoded.

This is problematic in the prior art when a synchronization pattern is reached.

Using the present invention allows the continues coding and decoding because the synchronization pattern can be removed from the signal and the remaining first section and second section of the coded bitstream can be joined, i.e. appended, to obtain a recreated coded bitstream where no influence of the synchronization pattern is present and the decoding of a code word can be performed using the next code word in a look ahead decoding.

A record carrier according to the invention comprises a signal comprising a user bit stream coded in a coded bitstream using a channel code where the signal comprises a synchronization pattern inserted between a first section of the coded bit stream and a second section of the bit stream where the synchronization pattern comprises p leading bits and q trailing bits such that all channel code constraints are met by a last code word of the first section together with the p leading bits and by a first code word of the second section together with the q trailing bits.

A record carrier comprising a signal according to the invention benefits from the advantages of the freely insertable synchronization pattern because more data can be stored on such a record carrier. This is because the state of the first code word of the second section no longer is fixed by the synchronization pattern but by the last code word of the first section, allowing more freedom in the code, resulting in a more efficient code.

A signal according to the invention comprises a user bit stream coded in a coded bitstream using a channel code where the signal comprises a synchronization pattern inserted between a first section of the coded bit stream and a second section of the bit stream where the synchronization pattern comprises p leading bits and q trailing bits such that all channel code constraints are met by a last code word of the first section together with the p leading bits and by a first code word of the second section together with the q trailing bits.

A signal according to the invention benefits from the advantages of the freely insertable synchronization pattern because more data can be comprised in such a signal. This is because the state of the first code word of the second section no longer is fixed by the synchronization pattern but by the last code word of the first section, allowing more freedom in the code, resulting in a more efficient code.

A recording device for recording a user bit stream on a record carrier comprises an input arranged to receive a user bitstream and to provide the user bitstream to a coder arranged to code a user bitstream into a coded bitstream by means of a channel code with a constraint, and a synchronization pattern insertion device for generating and inserting the synchronization pattern in the signal between a first section of the coded bitstream and a second section of the coded bitstream, and recording means for recording the coded bitstream in a signal on the record carrier where the synchronization pattern comprises p leading bits and q trailing bits such that all channel code constraints are met by a last code word of the first section together with the p leading bits and by a first code word of the second section together with the q trailing bits.

A recording device according to the invention benefits from the advantages of the freely insertable synchronization pattern because the recording device can record more data can on the same record carrier. This is because the state of the first code word of the second section no longer is fixed by the synchronization pattern but by the last code word of the first section, allowing more freedom in the code, resulting in a more efficient code. In addition the complexity of the recording device is reduced because the coder in the recording device does not need to consider the synchronization patterns that are to be inserted into the coded bitstream, but instead can be constructed to only convert the user bitstream into a coded bitstream. The synchronization pattern insertion device performs the generation of the synchronization pattern with the correct leading bits and trailing bits, depending on the exact insertion point of the synchronization pattern into the coded bitstream between the first section of the coded bitstream and the second section of the coded bitstream. The synchronization pattern insertion device only needs to look at a compliance of the leading bits and trailing bits of the synchronization pattern with the constraints of the channel code to match the leading bits to the end of the first section of the coded bitstream and to match the trailing bits to the start of the second section of the coded bitstream. Consequently there is no consideration of the states of the coder needed by the synchronization pattern insertion device. This reduces the complexity of the recorder.

A playback device for converting a coded bitstream in a signal on a record carrier into a user bit stream using a channel code with a constraint, comprises a signal retrieval device arranged for retrieving the signal from the record carrier, and a synchronization removal device arranged to remove a synchronization pattern located between a first section of the coded bitstream and a second section of the coded bitstream, and an appending device arranged for appending the second section to the first section to recreate a recreated coded bitstream, and a decoding device arranged to decode the recreated coded bistream into the user bit stream and to provide the user bitstream to an output of the playback device.

The retrieval device retrieves the signal from the record carrier. Since the synchronization pattern is freely insertable, it can also, before the decoding by the decoding device happens, be freely removed. After the appending device appends the second section to the first section, the coded bitstream as produced by the coder using the channel code is obtained. The coded bitstream complies also with the channel constraints of the channel code used for encoding. The sequence of states is intact without resets or alterations required or introduced by the synchronization pattern. Consequently the decoding device can decode the coded bitstream without further complications as would be introduced by the presence a regular synchronization pattern in the bitstream to be processed by the decoding device. The complexity of the decoding device is thus reduced. The removal of the synchronization pattern is uncomplicated because it was freely insertable in the first place. A straightforward removal without considerations towards the states of the decoder, nor any clock decoding or sliding window decoding, is possible.

### THE INVENTION WILL NOW BE DESCRIBED BASED ON FIGURES

FIG. 1 shows a freely insertable Synchronization pattern in between two successive Code Words of a Sliding-Block RLL Code.

FIG. 2 shows a freely insertable Synchronization pattern in between two successive Code Words of a Sliding-Block RLL Code in a frame structure.

FIG. 3 shows a structure of the insertable sync-pattern for a d=1, r=2 and k=22 RLL code.

FIG. 4 shows a recording device.

FIG. 5 shows a playback device.

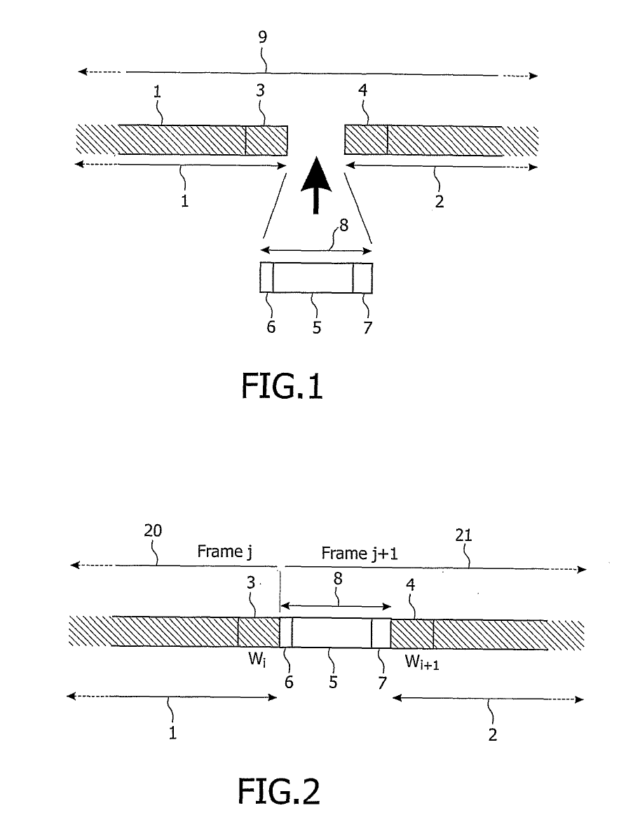

FIG. 1 shows a freely insertable Synchronization pattern in between two successive Code Words of a Sliding-Block RLL Code.

Extremely efficient d=1 and r=2 RLL codes have been recently devised.

Those RLL codes are realized as a concatenation of a number of sub-codes, where each sub-code is described in terms of a finite-state machine (FSM) with a large number of states. For instance, in the case of a byte-oriented RLL code with six sub-codes, five out of which have a 8-to-12 mapping (i.e. mapping 8 user bits onto 12 channel bits), and one has a 8-to-11 mapping, the resulting code-rate of the overall code amounts to R=48/71. The latter code has RLL constraints: d=1, r=2 and k=22. The k=22 constraint is realized through the property that each code word has at maximum 11 leading or trailing zeroes (and the all-zero code word is forbidden). The respective number of states of the FSM's of the six sub-codes C₁, C₂, C₃, C₄, C₅ and C₆ are: 28, 26, 24, 22, 20, 19. As an example, take a code word of C₆, where the next symbol is encoded with C₁: for some code words, the one-symbol look-ahead decoder has to differentiate between the maximum of 28 possible next-states. Incorporating this next-state diversity within the synchronization pattern (as is done in the state-of-the-art solution) would lead to a considerable increase of the length of the synchronization pattern, and this might partly prohibit the effectiveness of the gain in coding efficiency of the new RLL codes (the code being very efficient, but requiring too long synchronization patterns).

The solution to the above problem is to devise synchronization patterns that can readily be inserted (or pasted) into an RLL bitstream that has been generated by means of the sliding block encoder and its FSM. Such an “insertable” synchronization pattern is one that does not lead to runlength violations at its two boundaries, one between for instance the preceding code word and the synchronization pattern, the other between the synchronization pattern and for instance the subsequent code word.

FIG. 1 shows such a synchronization pattern 8 insertion operation between a first section 1 of the coded bitstream and a second section 2 of the coded bit stream. A first channel word, i.e. code word 3 is located at the end of the first section 1 and a second channel word, i.e. code word 4, is located at the beginning of the second section 2.

The first code word 3 is further denoted Wᵢ and the second code word 4 is denoted Wᵢ₊₁. Decoding the first code word Wᵢ into the corresponding user symbol or user word requires “look-ahead” into the next, i.e. second, code word Wᵢ₊₁. Because the first code word Wᵢ and the second code word Wᵢ₊₁ were encoded sequentially by the coder using the channel code with the constraint r=2 the combination of the first code word Wᵢ and the second code word Wᵢ₊₁ complies with that constraint.

In view of maintaining the r=2 constraint at the boundary between code words Wᵢ, Wᵢ₊₁ and synchronization pattern 8, the first two bits 6 and the last two bits 7 of the synchronization pattern 8 should be zero for a code with r=2. For instance, a synchronization pattern 8 may not start with |01 . . . , where “|” denotes the start or end of a group of bits such as the synchronization pattern 8, since that would violate the r=2 constraint in case the preceding code word ends with . . . 0010101|. Secondly, in view of the k-constraint, the maximum number of successive zeroes in the leading bits 6 or the trailing bits 7 of the synchronization pattern 8 should not be larger than the one that applies to the code words of the sliding block code, which maximum number equals 11 in the practical code that is currently being considered.

FIG. 2 shows a freely insertable Synchronization pattern in between two successive Code Words of a Sliding-Block RLL Code in a frame structure

In FIG. 2 the first section 1, second section 2 and synchronization pattern 8 are shown in relation to a frame structure as often used on a record carrier. The start of a next frame 21 is indicated by the dotted line. The next frame is denoted frame j+1. The previous frame 20 preceding the next frame 21 is denoted frame j.

The next-state decoding for first code word Wⱼ (which is the last code word 3 of frame j) proceeds by just ignoring the synchronization pattern 8 before the subsequent second code word 4, which is the first code word of the next frame j+1. Also, the state in which the encoder resides after a synchronization pattern 8, is not reset to a fixed state as in the state-of-the-art solution, but is dictated by the next-state of the last encoded code word, in this example the first code word 3 at the end of previous frame j, as given by the FSM (and thus as is listed the code-tables of the channel code used).

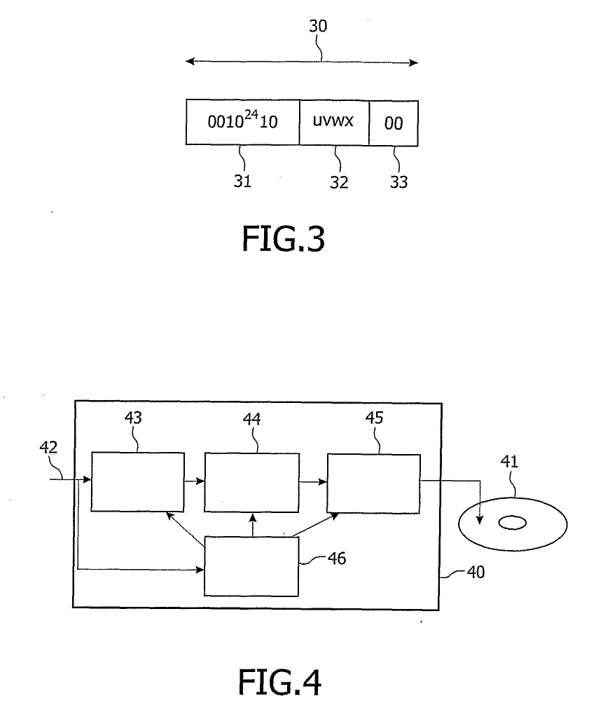

FIG. 3 shows a structure of the insertable sync-pattern for a d=1, r=2 and k=22 RLL code.

For the 48-to-71 RLL code with d=1, r=2 and k=22, a possible sync structure for an insertable synchronization pattern 30 is shown in FIG. 2. The synchronization pattern 30 has a synchronization pattern body 31 which reads 0010²⁴10 (29 bits), then a 4-bit synchronization pattern-ID 32, the four bit denoted uvwx respectively in FIG. 3, with one of the 7 frame-sync code words 0000, 0001, 0010, 0100, 1000, 1001, 0101, and two trailing bits 33, in this example being zeroes, at the end of the synchronization pattern 30. The synchronization pattern body 31 has an intentional violation of the k-constraint, exceeding the allowed maximum runlength of the code with exactly two bits. It should be noted that the first two bits of the synchronization pattern body 31 are zeroes, guaranteeing that the, in this case k-, constraint of the channel code is not violated if considered with the last code word of the previous section of the coded bitstream. The total length of the synchronization pattern amounts to 35 channel bits in this example.

Violations of other constraints, such as the r-constraint are of course also possible to ensure the detectability of the synchronization pattern.

For the last code word of the last frame in an ECC-cluster, one needs to be able to decode its next-state. For this purpose, one needs to encode a dummy symbol (possibly after an extra sync) which allows the one-symbol look-ahead during decoding. The dummy code word (and the optional extra sync) are part of the run-out area that is written after the ECC-cluster has been finished.

FIG. 4 shows a recording device 40 for recording a user bit stream on a record carrier 41. The input 42 receives a user bit stream that is to be recorded on the record carrier 41 and provides this user bit stream to the coder 43. In addition, the user bit stream or instructions for the recording device 40 can also be provided to a central processing device 46 to allow the appropriate coordination of the recording process under control of this central processing device 46. To achieve this coordination the central processing device 46 is coupled to the various devices 43, 44, 45 comprised in the recording device 40. The coder 43 uses a channel code to code the user bitstream received from the input into a coded bitstream. This channel code has a constraint, for instance a k constraint or an r constraint. The coded bitstream is subsequently provided by the coder 43 to the synchronization pattern insertion device 44. The synchronization pattern insertion device 44 generates, based on the chosen insertion point in the coded bitstream, a synchronization pattern, splits the coded bit stream into a first section and a second section and inserts the generated synchronization pattern between the first section and the second section of the coded bit stream. This results in a bit stream that is suitable for recording by the recording means 45 in the form of a signal on the record carrier 41. The synchronization pattern insertion device 44 generates the synchronization pattern such that the synchronization pattern comprises p leading bits and q trailing bits such that all channel code constraints are met by a last code word of the first section together with the p leading bits and by a first code word of the second section together with the q trailing bits.

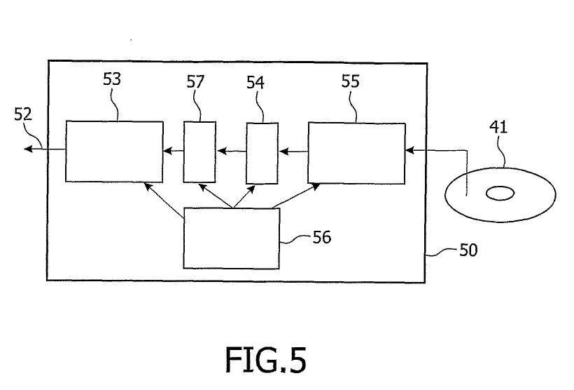

FIG. 5 shows a playback device 50 for converting a coded bitstream in a signal on a record carrier 41 into a user bit stream using a channel code with a constraint. The playback device 50 comprises a signal retrieval device 55 arranged for retrieving the signal from the record carrier 41. The signal retrieval device 55 provides the retrieved signal, comprising the coded bitstream with the inserted synchronization pattern to the synchronization removal device 54 where the synchronization pattern located between the first section of the coded bitstream and the second section of the coded bitstream is removed from the signal, The first section of the coded bitstream and the second section of the coded bitstream are then provided to the appending device 57 where the second section is appended to the first section to recreate a recreated coded bitstream. This recreated coded bitstream is subsequently provided by the appending device 57 to the decoder 53. The decoder 53 decodes the recreated coded bitstream into the user bitstream and provides the user bitstream to the output 52. The playback device also comprises a central processing device 56 that coordinates the various devices 53, 54, 55, 57 in the playback device 50.

Even though an implementation of the playback device uses the removal of the synchronization pattern from the signal before decoding, it is of course also possible to use a decoder that accepts the signal comprising the coded bitstream and the synchronization pattern and performs a skip of the synchronization pattern during decoding by adjusting an pointer used for addressing the bits in the signal.

1. A method of converting a user bitstream into a coded bitstream in a signal by means of a channel code, based on a signal format with a number of coded bitstream frames, wherein said channel code has a constraint, comprising the steps of:
coding the user bitstream into the coded bitstream,
partitioning the coded bit stream into a first section and a second section,
generating the synchronization pattern,
inserting the generated synchronization pattern between the first section and the second section,
where the synchronization pattern comprises p leading bits and q trailing bits such that all channel code constraints are met by a last code word of the first section together with the p leading bits and by a first code word of the second section together with the q trailing bits.

2. A method as claimed in claim 1, where said channel code is a sliding block code requiring a look-ahead decoding hereby using subsequent code words following a given code word that is to be decoded, and where the look-ahead decoding for the last code word of the first section uses the first code word of the second section, and where the channel bits of the synchronization pattern are irrelevant for said look-ahead decoding.

3. A method as claimed in claim 2, where said look-ahead decoding requires the first code word of the second section for the decoding of the last code word of first section.

4. Method for converting a coded bitstream in a signal into a user bit stream using a channel code where the signal comprises a synchronization pattern inserted between a first section of the coded bit stream and a second section of the bit stream where the synchronization pattern comprises p leading bits and q trailing bits such that all channel code constraints are met by a last code word of the first section together with the p leading bits and by a first code word of the second section together with the q trailing bits,
comprising the steps of:
removing the synchronization pattern from the signal,
appending the second section to the first section to obtain e recreated coded bistream,
decoding the recreated coded bitstream into a user bitstream based on the channel code.

5. Method as claimed in claim 4, where said channel code is a sliding block code requiring a look-ahead decoding hereby using subsequent code words following a given code word that is to be decoded.

6. A record carrier comprising a signal comprising a user bit stream coded in a coded bitstream using a channel code where the signal comprises a synchronization pattern inserted between a first section of the coded bit stream and a second section of the bit stream where the synchronization pattern comprises p leading bits and q trailing bits such that all channel code constraints are met by a last code word of the first section together with the p leading bits and by a first code word of the second section together with the q trailing bits.

7. A signal comprising a user bit stream coded in a coded bitstream using a channel code where the signal comprises a synchronization pattern inserted between a first section of the coded bit stream and a second section of the bit stream where the synchronization pattern comprises p leading bits and q trailing bits such that all channel code constraints are met by a last code word of the first section together with the p leading bits and by a first code word of the second section together with the q trailing bits.

8. Recording device for recording a user bit stream on a record carrier, the recording device comprising an input arranged to receive a user bitstream and to provide the user bitstream to a coder arranged to code a user bitstream into a coded bitstream by means of a channel code with a constraint, and a synchronization pattern insertion device for generating and inserting the synchronization pattern in the signal between a first section of the coded bitstream and a second section of the coded bitstream, and recording means for recording the coded bitstream in a signal on the record carrier where the synchronization pattern comprises p leading bits and q trailing bits such that all channel code constraints are met by a last code word of the first section together with the p leading bits and by a first code word of the second section together with the q trailing bits.

9. Playback device for converting a coded bitstream in a signal on a record carrier into a user bit stream using a channel code with a constraint, comprising a signal retrieval device arranged for retrieving the signal from the record carrier, and a synchronization removal device arranged to remove a synchronization pattern located between a first section of the coded bitstream and a second section of the coded bitstream, and an appending device arranged for appending the second section to the first section to recreate a recreated coded bitstream, and a decoding device arranged to decode the recreated coded bistream into the user bit stream and to provide the user bitstream to an output of the playback device.
